(19) United States
(12) Patent Application Publication
(10) Pub. No.: US 2019/0109365 A1
(43) Pub. Date: Apr. 11, 2019

(54) UHF DATA CARRIER AND METHOD FOR THE PRODUCTION THEREOF

(71) Applicant: Balluff GmbH, Neuhausen a.d.F (DE)

(72) Inventors: Norbert Popp, Wolfschlugen (DE); Robert Beutler, Denkendorf (DE); Oliver Pütz-Gerbig, Ostfildern, Ruit (DE); Werner Bloch, Eislingen (DE)

(21) Appl. No.: 16/151,691

(22) Filed: Oct. 4, 2018

(30) Foreign Application Priority Data
Oct. 6, 2017 (DE) 102017123273.74

(51) Int. Cl. H01Q 1/16; H01Q 1/38; H01Q 1/22

(52) U.S. Cl. CPC H01Q 1/16; H01Q 1/2225; H01Q 1/38

(57) ABSTRACT

A UHF data carrier (60) has a cylindrical plastic housing (50) having an open end and a closed end. A UHF mass tag (10) is arranged in the plastic housing (50). A metal plate (30) is arranged on the side of the UHF mass tag (10) facing away from the closed end. A spacer (20) is arranged between the UHF mass tag (10) and the metal plate (30). The spacer (20) is adhered to the UHF mass tag (10) and the metal plate (30) to form a composite for producing the UHF data carrier (60). The composite is inserted into the plastic housing (50) such that the UHF mass tag (10) faces towards the closed end of the plastic housing (50).

The present invention relates to a UHF data carrier. The invention also relates to a method for the production of the UHF data carrier.

### Prior Art

Tool data carriers can be used for identification of tools for machine tools. These are described and read out by means of RFID (Radio Frequency Identification). Such tool data carriers are currently manufactured with a standard length of 4.5 mm and a standard diameter of 10 mm according to the standard DIN 69873 and many tools have standard bores for receiving such tool data carriers. These tool data carriers contain RFID chips which are based on low frequency (LF) technology and work in a frequency range between 3 Hz and 30 kHz or which are based on high frequency (HF) technology and work in the frequency range of 30 kHz to 300 MHz. Such tool data carriers have a relatively small writing/reading distance in the range of a few millimetres. In tools which have, for example, a gripping groove, a very small writing/reading head for reading or describing the data carrier must therefore be positioned in the gripping groove. This is complex and expensive.

Furthermore, data carriers based on ultra high frequency (UHF) technology are known which work in the frequency range of 300 MHz to 3,000 MHz. These permit writing and reading distances in the range of several centimetres. When used in connection with metal tools, however, complex free zone measurements must be observed. These data carriers must be installed in an oriented manner, which is extremely difficult. UHF data carriers for tools which can be inserted into a 10×4.5 mm standard bore without being manually oriented are not known.

It is therefore the object of the present invention to provide a UHF data carrier which can be inserted by a user into a tool having a data carrier receptacle bore without manual adjustments having to be made here.

### DISCLOSURE OF THE INVENTION

This object is solved by a UHF data carrier which has a cylindrical plastic housing having an open end and a closed end. A UHF mass tag is arranged in the plastic housing. A metal plate is arranged on the side of the UHF mass tag facing away from the closed end. A spacer is arranged in the plastic housing between the UHF mass tag and the metal plate. A UHF mass tag is understood to be an element which is adapted to store data, wherein writing and reading of the data can take place wirelessly by means of UHF technology. In particular, the UHF mass tag is constructed such that a metal coating which can function as an RFID antenna is applied to a dielectric. A UHF-IC (Integrated circuit) is electrically connected to the metal coating. In order to prevent electrical currents from being passed into the UHF-IC via the metal coating and damaging it during the handling of the UHF mass tag, the dielectric, the metal coating and the UHF-IC are surrounded by an electrical insulating layer. The thickness of the electrical insulating layer ranges, in particular, from 0.1 mm to 0.6 mm. Here, an electrical insulating layer is understood to be a layer whose specific electrical resistance is more than 10⁸ Ω cm. If such a UHF mass tag were fitted to the metallic body of a tool without adjustment, its working frequency would be shifted such that it either would no longer function or would only be usable in a limited manner. Taking into account the environmental conditions, in a data carrier receiving bore, the metal plate shifts the working frequency of the UHF mass tag into its optimal region in its design. For this purpose, the thickness of the metal plate preferably ranges from 0.5 mm to 2.0 mm.

The open end of the artificial housing is necessary in order to be able to introduce the UHF mass tag, the metal plate and the spacer into the plastic housing. It is preferred that an external diameter of the metal plate corresponds to an internal diameter of the plastic housing. In this way, the metal plate can fulfil a further function by closing the open end of the plastic housing, in addition to the adjustment of the working frequency of the data carrier.

In order to achieve the desired adjustment of the working frequency of the UHF mass tag, a distance between the metal coating of the UHF mass tag and the metal plate preferably ranges from 0.2 mm to 1.2 mm. In order to be able to achieve this distance independently of the thickness of the electrical insulating layer, the spacer is provided between the UHF mass tag and the metal plate of the distance holder. A thickness of the distance holder preferably ranges from 0.1 mm to 0.6 mm.

The UHF-IC is preferably arranged on the side of the dielectric facing away from the metal plate.

While the spacer defines the distance between the metal coating and the metal plate, the plastic housing creates a lateral free space around the UHF mass tag. A thickness of the plastic housing preferably ranges from 0.25 mm to 1.00 mm. A distance between the metal coating and an inner side wall of the plastic housing is preferably at least 1 mm. This can be achieved, in particular, by a distance between the UHF mass tag and the inner side wall of the plastic housing likewise being at least 1 mm. The inner side wall is here understood to be the inside of the lateral surface of the plastic housing.

It is furthermore preferred that no fixed filling materials are arranged between the UHF mass tag and the inner side wall of the plastic housing, as well as between the UHF mass tag and the closed end of the plastic housing, because these could lead to a detuning of the UHF mass tag. Instead of this, the UHF mass tag, the metal plate and the space are preferably surrounded by air in the plastic housing. The plastic housing is preferably formed cylindrically and has a length of 4.5 mm and an external diameter of 10 mm. This enables positioning of the UHF data carrier in a data carrier receiving bore according to DIN 69873.

The production of the UHF data carrier can take place in a method in which, firstly, a composite is produced. For this purpose, the spacer is adhered to the UHF mass tag on one side and adhered to the metal plate on the opposite side. This composite is then inserted into the plastic housing such that the UHF mass tag faces towards the closed end of the plastic housing.

In order to fix the composite in the plastic housing, it is preferred that the metal plate is adhered to the inner side wall of the plastic housing. When the external diameter of the metal plate corresponds to an internal diameter of the plastic housing, the composite is thus, in particular, pushed firstly into the plastic housing through the open end, and the metal plate is then adhered to the inner side wall from the outside, for example, by means of a superglue.

### BRIEF DESCRIPTION OF THE DRAWINGS

Exemplary embodiments of the invention are depicted in the drawings and are described in more detail here as described below.

FIG. 1 shows a schematic sectional view of a UHF mass tag for a UHF data carrier according to an exemplary embodiment of the invention.

FIG. 2 shows a schematic sectional view of a composite for a UHF mass tag according to an exemplary embodiment of the invention.

FIG. 3 shows a schematic sectional view of a UHF data carrier according to an exemplary embodiment of the invention.

FIG. 4 shows a schematic sectional view of a data carrier receiving bore which can receive a UHF data carrier according to an exemplary embodiment of the invention.

FIG. 5 shows a schematic sectional view of a data carrier receiving bore into which a UHF data carrier according to an exemplary embodiment of the invention is inserted.

Exemplary embodiments of the invention

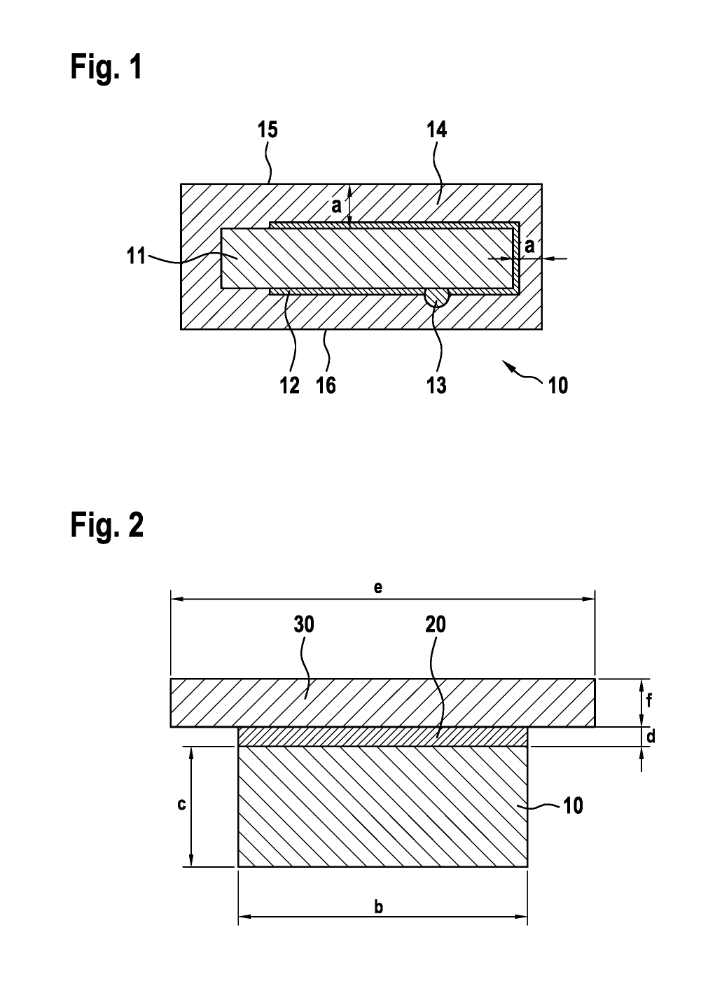

A UHF mass tag 10 which can be used in a UHF data carrier according to an exemplary embodiment of the invention is depicted in FIG. 1. This UHF mass tag 10 has a cylindrical ceramic plate as a dielectric 11. A metal coating 12 is applied as an RFID antenna on the upper side, the underside and a part of the lateral surface of the dielectric 11. Furthermore, on the underside of the dielectric 11, a UHF-IC 13 is arranged which is electrically connected to the metal coating 12. This can be operated according to the RFID protocol EPC Class 1 Gen 2 according to ISO 18000-6C with a working frequency ranging from 866 MHz to 868 MHz or ranging from 902 MHz to 928 MHz. The dielectric 11, the metal coating 12 and the UHF-IC 13 are surrounded by an electrical insulating layer 14 made of an epoxy resin which has a thickness a of 0.3 mm. The electrical insulating layer 14 has an upper side 15 and an underside 16. The UHF-IC faces towards the underside 16.

The UHF mass tag 10 is substantially cylindrical and has a diameter b of 6 mm and a height c of 2.5 mm. As depicted in FIG. 2, it is adhered to a spacer 15 on the upper side 20, said spacer having the same cross-section as the UHF mass tag 10. The spacer 20 consists of polyurethane (PUR) and has a thickness d of 0.3 mm. A metal plate 30 made of S235JR construction steel is adhered to the spacer 20. This metal plate has a cylindrical cross-section having a diameter e of 9 mm. Its thickness f is 1 mm. A composite 40 is obtained by the adhering of the UHF mass tag 10 of the spacer 20 and the metal plate 30. The distance between the metal coating 12 and the metal plate 30 in the composite 40 is 0.6 mm.

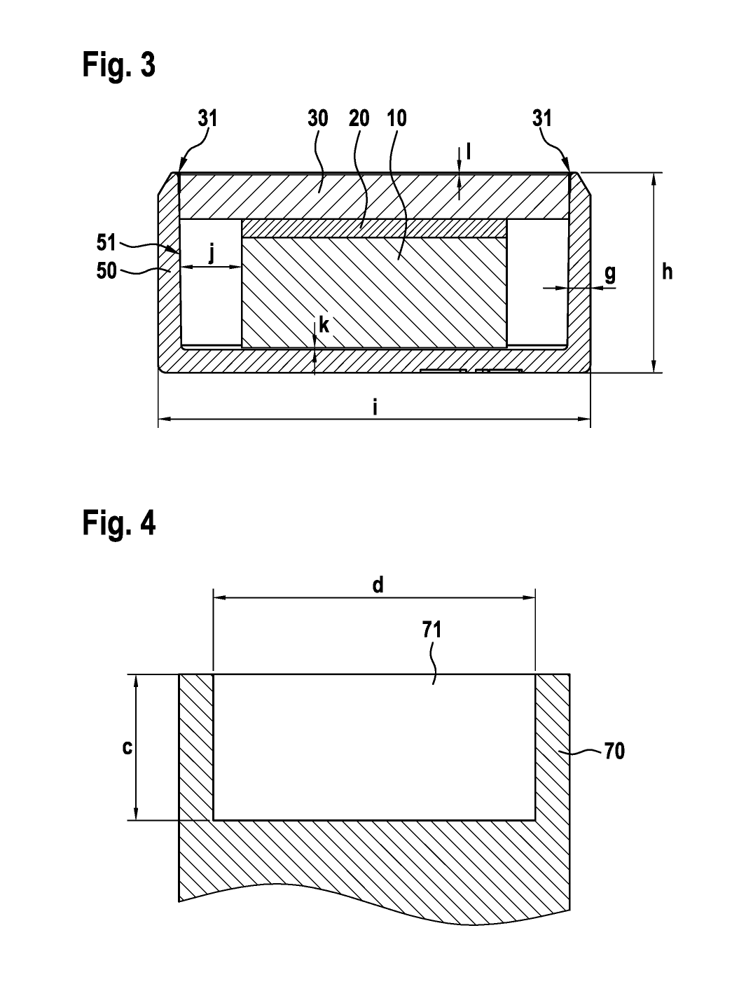

As depicted in FIG. 3, this composite 40 is inserted into a plastic housing 50. The plastic housing 50, which consists of polyamide 12 reinforced with 30% glass fibres (PA 12 GF30) is cylindrical and open on its upper end and closed on its lower end. The wall thickness g of the plastic housing 50 is 0.5 mm. Its height h is 4.5 mm and its external diameter i is 10 mm. When the composite 40 is inserted into the plastic housing 50, the distance j between the inner wall 51 of the plastic housing and the UHF mass tag 10 is 1.5 mm. Because the metal coating 12 is surrounded by the 0.3 mm thick insulating layer 14, the distance between the metal coating 12 and the side wall 51 is 1.8 mm. The composite 40 is positioned in the plastic housing 50 such that an air gap having a thickness k of 0.1 mm remains free between the UHF mass tag 10 and the base of the plastic housing 50. A gap having a height I of 0.1 mm thus remains between the metal plate 30 and the upper side of the plastic housing 50. This is wetted on its edges with an adhesive 31, such that the metal plate 30 is adhered to the inner wall 51 of the plastic housing 50.

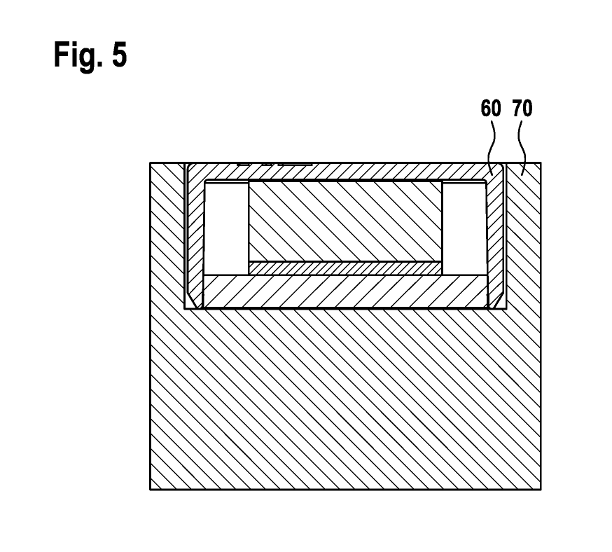

In FIG. 4, a cut-out of a metal tool 70 is depicted in which a data carrier receiving bore 71 is located. According to the DIN 69873 standard, the data carrier bore 71 has a height of 4.5 mm and a diameter i of 10 mm. The dimensions of the data carrier receiving bore thus correspond to the external dimensions of the UHF data carrier 60. In FIG. 5 it is depicted how the UHF data carrier 60 can be inserted into the tool 70. The UHF data carrier enables reading out of the data saved in the UHF-IC 13 from a distance of several centimetres.

1. UHF Data carrier, having
a cylindrical plastic housing having an open end and a closed end,
a UHF mass tag which is arranged in the plastic housing,
a metal plate which is arranged on the side of the UHF mass tag facing away from the closed end, and
a spacer which is arranged between the UHF mass tag and the metal plate.

2. The UHF data carrier according to claim 1, further wherein an external diameter of the metal plate corresponds to an internal diameter of the plastic housing.

3. UHF data carrier according to claim 1, further wherein a thickness of the metal plate ranges from 0.5 mm to 2.0 mm.

4. The UHF data carrier according to claim 1, further wherein a distance (j) between the UHF mass tag and an internal side wall of the plastic housing is at least 1 mm.

5. The UHF data carrier according to claim 1, further wherein a wall thickness of the plastic housing ranges from 0.25 to 1.00 mm.

6. The UHF data carrier according to claim 1, further wherein a thickness of the spacer ranges from 0.1 mm to 0.6 mm.

7. The UHF data carrier according to claim 1, further wherein the UHF mass tag has a dielectric, a metal coating arranged on the dielectric, an UHF-IC which is electrically connected to the metal coating and an electrical insulating layer which surrounds the dielectric, the metal coating and the UHF IC.

8. The UHF data carrier according to claim 7, further wherein the UHF-IC is arranged on the side of the dielectric facing away from the metal plate.

9. The UHF data carrier according to claim 7, further wherein the electrical insulating layer has a thickness ranging from 0.1 mm to 0.6 mm.

10. The UHF data carrier according to claim 7, further wherein a distance between the metal coating and the metal plate ranges from 0.3 mm to 1.2 mm.

11. The UHF data carrier according to claim 7, further wherein a distance between the metal coating and an inner side wall of the plastic housing is at least 1 mm.

12. The UHF data carrier according to claim 1, further wherein the plastic housing has a length of 4.5 mm and an external diameter of 10 mm.

13. The UHF data carrier of claim 1, further wherein the spacer is adhered to the UHF mass tag and the metal plate to form a composite and the composite is inserted into the plastic housing such that the UHF mass tag faces towards the closed end of the plastic housing.

14. The Method according to claim 13, further wherein the metal plate is adhered to the inner side wall of the plastic housing.
